(19) United States
(12) Patent Application Publication
(10) Pub. No.: US 2020/0073491 A1
(43) Pub. Date: Mar. 5, 2020

(54) ELECTRONIC ERASE DEVICE

(71) Applicant: eGalax_eMPIA Technology Inc., Taipei (TW)

(72) Inventor: Chin-Fu CHANG, Taipei (TW)

(21) Appl. No.: 16/219,468

(22) Filed: Dec. 13, 2018

(30) Foreign Application Priority Data
Aug. 30, 2018 (TW) 107130378

(51) Int. Cl. G06F 3/041; G06F 3/0354; G06F 3/038; G06F 3/0484

(52) U.S. Cl. CPC G06F 3/041; G06F 3/03544; G06F 3/04845; G06F 3/03545; G06F 3/0383

(57) ABSTRACT

An electronic erase device includes at least three electromagnetic signal emission elements, and after a touch panel detects a pattern formed by at least three electromagnetic signal emission elements, the touch panel can erase handwriting upon a user-defined erase area. As a result, it is excessively-high convenient to write and erase on touch panel by using stylus and electronic erase device alternatively in meeting, teaching and working application.

This application claims the priority benefit of Taiwan patent application number 107130378, filed on Aug. 30, 2018.

### BACKGROUND OF THE INVENTION

### 1. Field of the Invention

The present invention relates to an electronic erase device, more particularly to an electronic erase device including at least three electromagnetic signal emission devices, and after a touch panel detects a pattern formed by the at least three electromagnetic signal emission devices, a handwriting shown on the touch panel can be erased by a user-defined erase area.

### 2. Description of the Related Art

Generally, the computer is equipped with a keyboard and a mouse as main input devices, while the notebook computer has an additional touchpad. In recent years, the main function of the computer is no longer focused on work and is changed to provide entertainment and leisure service; therefore, tablets and smartphones are developed to meet the requirement in entertainment and leisure service. The main manner of controlling tablet and smart phone is to touch on the screen, such interaction interface greatly changes the mobile electronic device, and the mobile electronic device can be carried more easily without the keyboard and mouse. With advancement in touch control technology, the touch control technology can also be applied to large-sized LCD televisions, so that the LCD television can provide an interaction interface for the user to touch an icon shown on the LCD screen to trigger a corresponding function, or for the user to write and draw on the LCD screen. The writing and drawing function can be applied to conferences, teaching and work. As a result, the touch control LCD TV has potential to be a popular electronic product in the 3C market.

In the application of writing and drawing on a LCD TV, using finger is not convenient enough, because the friction between the finger and the touch panel surface is higher and the finger cannot move quickly, it is also disadvantageous to write a large amount of texts, lines and patterns on the LCD TV by user's finger. Therefore, a stylus capable of writing on the touch panel is developed. Because of having a smaller tip and lower friction than that of the user's finger, the stylus is suitable for precisely clicking images and quickly writing thin lines. Furthermore, the tip of the stylus is conical and suitable for oblique writing, the touch area sensed by the touch panel upon the capacitance of the stylus can be increased during the oblique writing, so thicker lines can be generated on the touch panel. As a result, the writing operation of the stylus on the LCD TV can present a diverse and rich content.

Most of the stylus pens for writing on the touch LCD TVs are active styluses, and a body of the active stylus can emit electromagnetic signals and change the capacitance value sensed by the touch panel. Besides emitting the electromagnetic signal to write on the touch panel, the active stylus can also emit another electromagnetic signal to erase the handwriting on the touch panel. However, since a limited area of the tip or the tail of the stylus, it is hard to erase the handwriting by a large area. Therefore, what is needed is to develop an erase device to solve above-mentioned problems.

### SUMMARY OF THE INVENTION

In order to solve the aforementioned conventional problems and drawbacks, the inventor of the present invention collects related information and performs multiple tests and modifications base on years of research experience in the industry, so as to develop an electronic erasing device of the present invention.

An objective of the present invention is to provide an electronic erase device comprising a plurality of electromagnetic signal emission elements, and a number of the electromagnetic signal emission elements can be three, and a touch panel can erase handwriting upon a user-defined erase area after the touch panel detects a pattern formed by at least three of the plurality of electromagnetic signal emission elements. It is excessively-high convenient to write and erase on touch panel by using stylus and electronic erase device alternatively in meeting, teaching and working application.

Another objective of the present invention is that a circuit board of the electronic erase device further comprises a first button and a second button disposed thereon, and the first button is configured to conduct or disconnect the electrical connection between the plurality of electromagnetic signal emission elements and the power source device, so as to emit an erase signal; and, the second button is configured to conduct or disconnect the electrical connection between the plurality of electromagnetic signal emission elements and the power source device, so as to emit a large-area painting signal.

### BRIEF DESCRIPTION OF THE DRAWINGS

The structure, operating principle and effects of the present invention will be described in detail by way of various embodiments which are illustrated in the accompanying drawings.

FIG. 1 is a three dimensional structural view of appearance of the electronic erase device of the present invention.

FIG. 2 is a perspective exploded view of a structure of the electronic erase device of the present invention.

FIG. 3 is a top view of a structure of the electronic erase device of the present invention.

FIG. 4 is a schematic view of the electronic erase device of the present invention applied to a touch panel.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

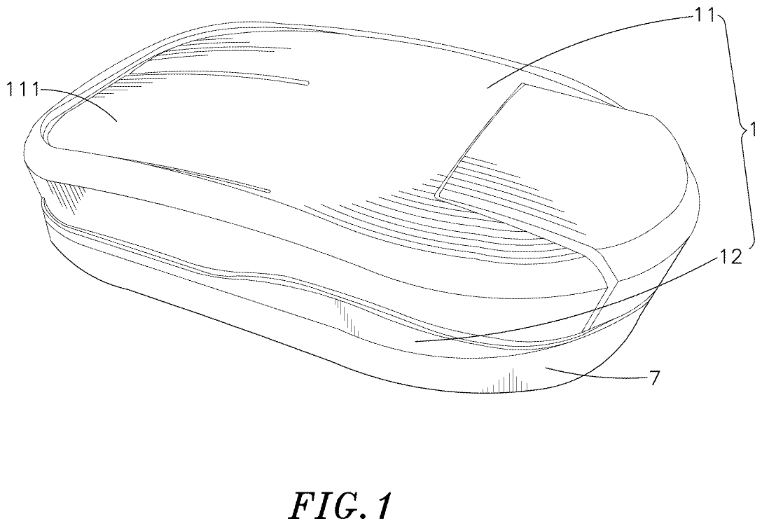

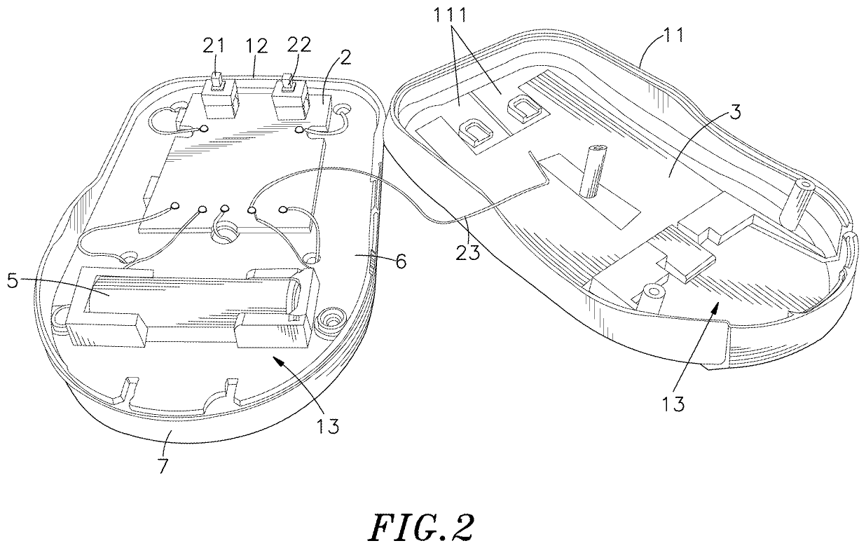

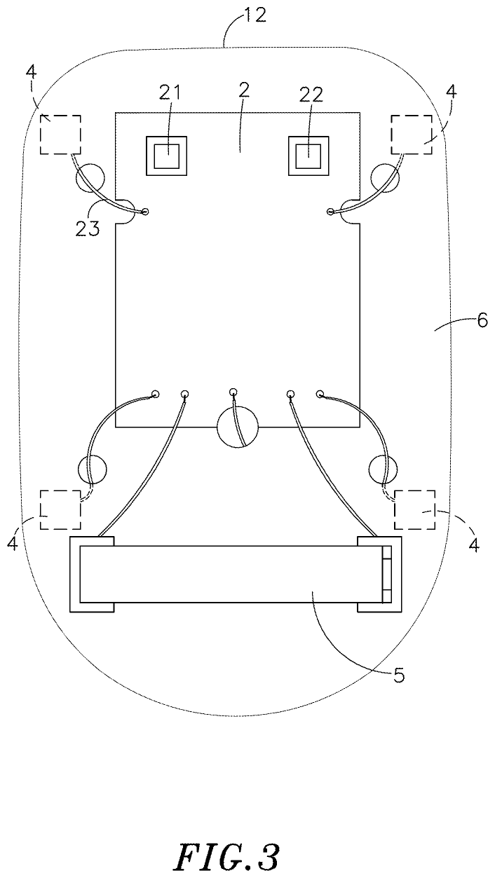

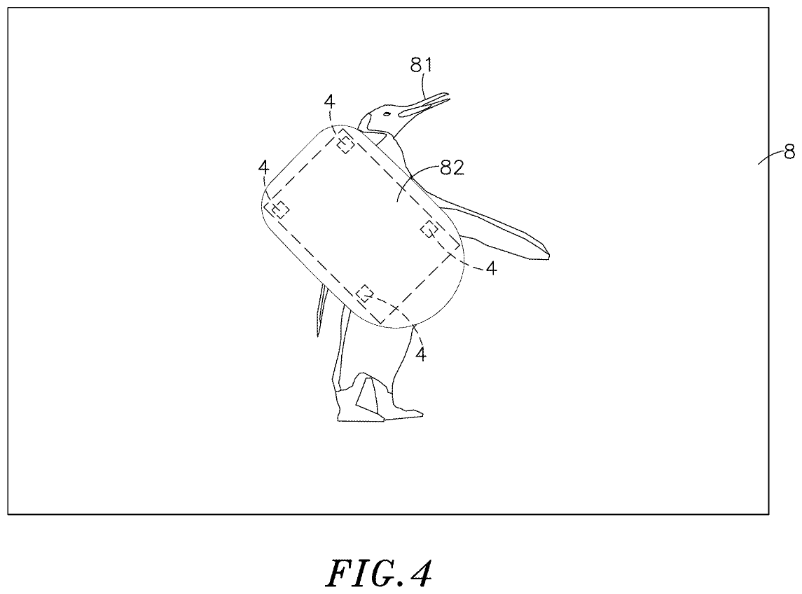

Please refer to FIGS. 1 to 4, which show a three dimensional structural view of appearance of the electronic erase device, a perspective exploded view of a structure of the electronic erase device, a top view of a structure of the electronic erase device, and a schematic view of the electronic erase device of the present invention applied to a touch panel 8, respectively. In an embodiment, the electronic erase device of the present invention is applied to a large-sized touch-controlled LCD television, for erasing handwriting written on the touch panel by a capacitive stylus. The aforementioned handwriting can mean words, and single or multiple color drawings painted by the stylus. The electronic erase device comprises a case 1 with a mouse-like shape to facilitate a user to hold for operation, and the case 1 can comprise a cover 11 and a base 12, and an accommodation space 13. The cover 11 comprises two keypads 111, and the accommodation space 13 is formed between the cover 11 and the base 12, the electronic erase device further comprises a flexible pad 7, a circuit board 2 and a plurality of electromagnetic signal emission elements 4 which all are accommodated in the accommodation space 13.

The flexible pad 7 is disposed on an external side of the base 12 and is configured to provide a flexible contact surface and a cushion area when the flexible pad 7 contacts the touch panel 8. In an embodiment, the flexible pad 7 can be made of a conductive fabric, so as to enhance strength of emission signals of an electromagnetic signal emission elements 4.

The circuit board 2 is disposed on the base 12 and comprises a first button 21 and a second button 22 disposed under the two keypads 111 of the cover 11, so that the user's finger may press the keypads 111 to trigger a switch by pressing the first button 21 or the second button 22. The first button 21 is configured to conduct or disconnect the electrical connection between the plurality of electromagnetic signal emission elements 4 and a power source device 5, for emitting an erase signal. The second button 22 is configured to conduct or disconnect the electrical connection between the plurality of electromagnetic signal emission elements 4 and the power source device 5, for emitting a large-area painting signal. It should be noted that a person skilled in the art may interchange the functions of the first button 21 and the second button 22, or modify both of the first button 21 and the second button 22 to emit erase signals or painting signals, without departing from the spirit and scope of the disclosure set forth in the claims.

A partition plate 6 is further disposed between the base 12 and the circuit board 2, and the power source device 5 is disposed above the partition plate 6, and the plurality of electromagnetic signal emission elements 4 are disposed below the partition plate 6.

An electrostatic sensing plate 3 is arranged on an inner side of the cover 11. In this embodiment, the electrostatic sensing plate 3 is directly attached to the inner side of cover 11, and configured to detect an electrostatic charge of human body and conduct the electrostatic charge to the circuit board 2 through a conductive wire 23. The electrostatic sensing plate 3 is made of a metal sheet, and preferably, the metal sheet can be a copper foil; however, a gold foil, a silver foil, an aluminum foil or a tin foil may also be applied as a material of the metal sheet. In other embodiment, the electrostatic sensing plate 3 can be disposed on an outer surface of the cover 11, so that user's hand may directly touch the electrostatic sensing plate 3 to conduct the electrostatic charge. It should be noted that above-mentioned modification does not depart from the spirit and scope of the disclosure set forth in the claims.

The plurality of electromagnetic signal emission elements 4 are arranged on and electrically connected to the bottom of the circuit board 2 through the conductive wires 23 corresponding thereto, and are configured to receive the electrostatic charge conducted form the electrostatic sensing plate 3 to the circuit board 2, so as to form an electrical loop with the touch panel 8 through human body for emitting the erase signal. For example, when user's finger, palm or other conductive body part (the finger is taken as an example for illustration hereafter) contacts the electrostatic sensing plate 3 and the plurality of electromagnetic signal emission elements 4 contact an upper surface of a capacitive touch panel 8, the finger contacting the electrostatic sensing plate 3 can be electrically connected to the plurality of electromagnetic signal emission elements 4 through the plurality of the conductive wires 23, and an amount of capacitive coupling formed between the plurality of electromagnetic signal emission elements 4 and the touch panel 8 through an electrical loop formed with the human body may be changed, so that the plurality of electromagnetic signal emission elements 4 can emit the erase signal to erase the handwriting 81.

A number of the plurality of electromagnetic signal emission elements 4 can be at least three. When the touch panel 8 detects a pattern formed by at least three of the plurality of electromagnetic signal emission elements 4, the touch panel 8 can determine that the detected pattern is not formed by single electromagnetic signal emission element (such as a stylus) for creating handwriting 81 but the pattern formed at least three electromagnetic signal emission elements 4 for erasing the handwriting 81. As a result, the handwriting 81 is erased according to a user-defined erase area 82. In the present embodiment, the erase area 82 can be a rectangular contour slightly smaller than a mouse contour; however, the erase area 82 in the present invention is not limited to above example and may be any geometrical pattern without departing from the spirit and scope of the disclosure set forth in the claims. In a preferred embodiment, the number of the plurality of electromagnetic signal emission elements 4 can be four, and the four electromagnetic signal emission elements 4 can be arranged in a rectangular shape or a long rectangular shape.

The power source device 5 is arranged on the base 12, and electrically connected to the plurality of electromagnetic signal emission elements 4 and the circuit board 2, and configured to supply power to the plurality of electromagnetic signal emission elements 4. The power source device 5 includes a battery holder and a battery electrically connected to the battery holder, and the battery can be a lithium battery, a nickel hydride battery, a nickel-cadmium battery, an alkaline battery, or zinc-carbon battery. It should be noted that the person skilled in the art may use an external transformer to electrically connect to a socket with a commercial power system, and use a cable to electrically connect the electronic erase device and the external transformer, so as to supply DC power supply to the electronic erase device. It should be noted that the above-mentioned modification does not depart from the spirit and scope of the disclosure set forth in the claims.

For the purpose of forming an electronic write and erase tool in meeting, teaching and working, the touch panel 8 can receive the electromagnetic signal emitted from electromagnetic signal emission elements 4, and determine whether the number of the electromagnetic signal is single or multiple, and the touch panel 8 creates and shows the handwriting 81 when the touch panel 8 determines that the received electromagnetic signal is single signal emitted from the stylus; or the touch panel 8 can generate an erase signal to erase the handwriting 81 according to the user-defined erase area 82 when the touch panel 8 determines that the received electromagnetic signals are multiple signals. On the purpose of user's-inertia and intuitive use, the erase area 82 may be about equal to an area of the flexible pad 7 on the bottom of electronic erase device, so as to accelerate the speeding of erasing the handwriting 81 by the large-area erase operation. As a result, the electronic write and erase tools can be provided to the user.

According to the electronic erase device shows in FIGS. 1 to 4, it may be understood that the electronic erase device of the present invention comprises the at least three electromagnetic signal emission elements, and the handwriting can be erased according to the user-defined erase area after the touch panel detects the pattern formed by at least three of the electromagnetic signal emission elements. It is excessively-high convenient for user to write and erase on touch panel by using stylus and electronic erase device alternatively in meeting, teaching and working. Furthermore, the circuit board of the electronic erase device further comprises the first button and the second button disposed thereon. The first button is configured to conduct or disconnect the electrical connection between the plurality of electromagnetic signal emission elements and the power source device, so as to emit an erase signal. The second button is configured to conduct or disconnect the electrical connection between the plurality of electromagnetic signal emission elements and the power source device, so as to emit a large-area painting signal. The electronic erase device can be applied in meeting, teaching or working application, to replace the conventional whiteboard, dry-erase marker and whiteboard eraser in meeting room; furthermore, since the electronic erase device produce no dust and waste during the writing and erasing operation, it is also helpful to user's health and is environmental-friendliness. As a result, the electronic erase device of the present invention is very competitive in the market.

The present invention disclosed herein has been described by means of specific embodiments. However, numerous modifications, variations and enhancements can be made thereto by those skilled in the art without departing from the spirit and scope of the disclosure set forth in the claims.

1. An electronic erase device applied to erase handwriting shown on a touch panel, comprising:
a case comprising a cover, a base and an accommodation space formed between the cover and the base;
a circuit board disposed in the accommodation space and arranged on the base;
an electrostatic sensing plate disposed in the accommodation space and arranged on the inner side of the cover, and configured to detect electrostatic charge of human body and conduct the electrostatic charge to the circuit board through a conducting wire;
a plurality of electromagnetic signal emission elements disposed in the accommodation space, and arranged on and electrically connected to the bottom of the circuit board, and configured to receive the electrostatic charge conducted form the electrostatic sensing plate to the circuit board, to form an electrical loop with the touch panel through a human body, so as to emit an erase signal; and
a power source device disposed in the accommodation space and arranged on the base and electrically connected to the electromagnetic signal emission elements and the circuit board, and configured to supply electric power to the electromagnetic signal emission elements.

2. The electronic erase device according to claim 1, wherein the circuit board further comprises a first button and a second button, the first button is configured to conduct or disconnect the electrical connection between the electromagnetic signal emission elements and the power source device, so as to emit an erase signal, and the second button is configured to conduct or disconnect the electrical connection between the electromagnetic signal emission elements and the power source device, so as to emit a large-area painting signal.

3. The electronic erase device according to claim 1, wherein the electrostatic sensing plate is made of a metal sheet, and the metal sheet is a copper foil.

4. The electronic erase device according to claim 1, wherein the case is in a mouse-like shape, and the cover of the case comprises two keypads.

5. The electronic erase device according to claim 1, further comprising a flexible pad disposed on an external side of the base and configured to provide a flexible contact surface and a cushion area when contacting the touch panel, wherein the flexible pad is made of conductive fabric.

6. The electronic erase device according to claim 1, wherein a number of the electromagnetic signal emission elements is at least three, and the touch panel erases the handwriting according to a user-defined erase area after the touch panel detects a pattern formed by at least three of the electromagnetic signal emission elements.

7. The electronic erase device according to claim 6, wherein the number of the electromagnetic signal emission elements is four, and the four electromagnetic signal emission elements are arranged in a rectangular shape or a long rectangular shape.

8. The electronic erase device according claim 1, further comprising a partition plate disposed between the base and the circuit board, and the power source device is disposed above the partition plate, and the electromagnetic signal emission elements are disposed below the partition plate.
